(19) United States
(12) Patent Application Publication
(10) Pub. No.: US 2019/0295526 A1
(43) Pub. Date: Sep. 26, 2019

(54) DIALOGUE CONTROL DEVICE, DIALOGUE SYSTEM, DIALOGUE CONTROL METHOD, AND RECORDING MEDIUM

(71) Applicant: CASIO COMPUTER CO., LTD., Tokyo (JP)

(72) Inventors: Erina ICHIKAWA, Sagamihara-shi (JP); Takahiro TOMIDA, Tokyo (JP)

(73) Assignee: CASIO COMPUTER CO., LTD., Tokyo (JP)

(21) Appl. No.: 16/352,800

(22) Filed: Mar. 13, 2019

(30) Foreign Application Priority Data
Mar. 26, 2018 (JP) 2018-058200
Dec. 28, 2018 (JP) 2018-247382

(51) Int. Cl. G10L 13/04; G10L 25/48; B25J 11/00

(52) U.S. Cl. CPC G10L 13/043; B25J 11/0005; G10L 25/48

(57) ABSTRACT

A first robot acquires reaction determination results that includes a result obtained by determining a reaction of a predetermined target to an utterance by the first robot and a result obtained by determining a reaction of a predetermined target to an utterance by a second robot provided separately from the first robot, and controls, based on the acquired reaction determination results, an utterance by at least one of a plurality of utterance devices including the first robot and the second robot.

### CROSS-REFERENCE TO RELATED APPLICATION

This application claims priority based on Japanese Patent Application No. 2018-058200 filed on Mar. 26, 2018 and Japanese Patent Application No. 2018-247382 filed on Dec. 28, 2018, the entire contents of which are hereby incorporated herein.

### FIELD

The present disclosure relates to a dialogue control device, a dialogue system, a dialogue control method, and a recording medium.

### BACKGROUND

Development of devices such as robots that communicate with human beings is proceeding, and familiarity is an important point in spreading such devices such as robots. For example, Unexamined Japanese Patent Application Kokai Publication No. 2006-071936 discloses a technique of learning user's preferences through a dialogue with a user and having a dialogue suitable for the user's preferences.

### SUMMARY

According to one aspect of the present disclosure, the dialogue control device includes a processor, and the processor is configured to acquire reaction determination results that include a result obtained by determining a reaction of a predetermined target to an utterance by a first utterance device and a result obtained by determining a reaction of the predetermined target to an utterance by a second utterance device provided separately from the first utterance device, and control, based on the acquired reaction determination results, the utterance by at least one of a plurality of utterance devices including the first and second utterance devices.

According to another aspect of the present disclosure, the dialogue system includes a first utterance device and a second utterance device that are configured to be able to utter; and a dialogue control device comprising a processor. The processor of the dialogue control device is configured to acquire reaction determination results that include a result obtained by determining a reaction of a predetermined target to an utterance by the first utterance device and a result obtained by determining a reaction of the predetermined target to an utterance by the second utterance device provided separately from the first utterance device; and control, based on the acquired reaction determination results, the utterance by at least one of a plurality of utterance devices including the first and second utterance devices.

According to yet another aspect of the present disclosure, the dialogue control method includes acquiring reaction determination results that include a result obtained by determining a reaction of a predetermined target to an utterance by a first utterance device and a result obtained by determining a reaction of the predetermined target to an utterance by a second utterance device provided separately from the first utterance device, and controlling, based on the acquired reaction determination results, the utterance by at least one of a plurality of utterance devices including the first and second utterance devices.

According to still another aspect of the present disclosure, the recording medium stores a program, the program causing a computer to function as a reaction acquirer for acquiring reaction determination results that include a result obtained by determining a reaction of a predetermined target to an utterance by a first utterance device and a result obtained by determining a reaction of the predetermined target to an utterance by a second utterance device provided separately from the first utterance device, and an utterance controller for controlling, based on the reaction determination results acquired by the reaction acquirer, the utterance by at least one of a plurality of utterance devices including the first and second utterance devices.

### BRIEF DESCRIPTION OF THE DRAWINGS

A more complete understanding of this application can be obtained when the following detailed description is considered in conjunction with the following drawings, in which:

FIG. 1 is a diagram showing a configuration of a dialogue system according to Embodiment 1 of the present disclosure;

FIG. 2 is a front view of a robot according to Embodiment 1;

FIG. 3 is a block diagram showing a configuration of the robot according to Embodiment 1;

FIG. 4 is a diagram showing an example of a voice reaction polarity determination table according to Embodiment 1;

FIG. 5 is a flowchart showing a flow of dialogue control processing according to Embodiment 1;

FIG. 6 is a flowchart showing a flow of user specification processing according to Embodiment 1;

FIG. 7 is a flowchart showing a flow of voice determination processing according to Embodiment 1;

FIG. 8 is a flowchart showing a flow of facial expression determination processing according to Embodiment 1;

FIG. 9 is a flowchart showing a flow of behavior determination processing according to Embodiment 1;

FIG. 10 is a flowchart showing a flow of preference determination processing according to Embodiment 1; and

FIG. 11 is a block diagram showing a configuration of a dialogue system according to Embodiment 2.

### DETAILED DESCRIPTION

Hereinafter, embodiments of the present disclosure will be described in detail with reference to the drawings.

### Embodiment 1

A dialogue system 1 according to Embodiment 1 of the present disclosure comprises a plurality of robots 100. The plurality of robots 100 is arranged in a living space such as an office or a residence of a predetermined target, and the plurality of robots 100 has a dialogue with a predetermined target. In the following description, an example will be described in which two robots 100 have a dialogue with the predetermined target, and the dialogue system 1 may comprise three or more robots 100.

Here, the predetermined target is a user who utilizes a dialogue system, and typically, is an owner of the dialogue system, a family member or friend of the owner, or the like. Examples of the predetermined target other than human beings include an animal kept as a pet and another robot different from the robot 100.

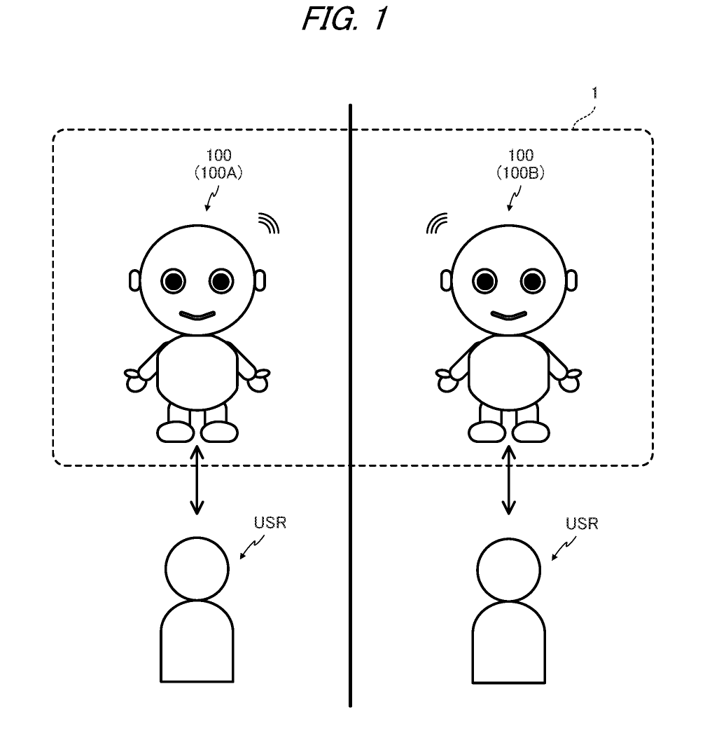

As shown in FIG. 1, the dialogue system 1 includes two robots 100 capable of communicating with each other, and has a dialogue with a user USR. Here, for convenience of explanation, a robot 100 on the left side of the page of FIG. 1 is assumed to be a robot 100A, and a robot 100 on the right side of the page of FIG. 1 is assumed to be a robot 100B. Note that, when explaining the robot 100A and the robot 100B without any distinction, either robot or these robots may be collectively referred to as “robot 100”. The robot 100A and the robot 100B are arranged at places different from each other, and are provided at places where the same predetermined target cannot recognize both utterances of the robot 100A and the robot 100B. For example, the robot 100A is arranged in an office of the predetermined target, and the robot 100B is arranged in a housing of the predetermined target away from the office. Alternatively, the robot 100A is arranged at a facility which the predetermined target goes to, and the robot 100B is arranged at another facility away from the facility which the predetermined target goes to.

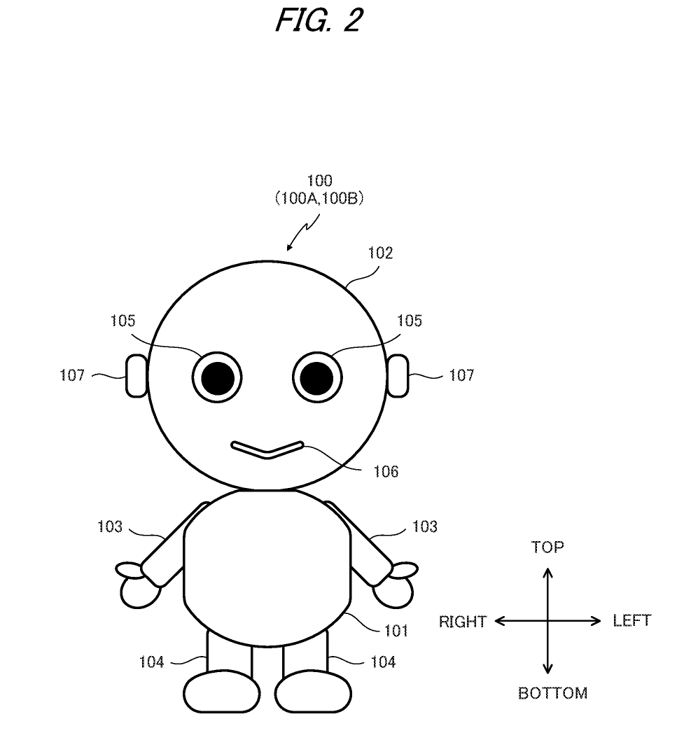

As shown in FIG. 2, the robot 100 is a robot having a stereoscopic shape externally imitating a human being. The exterior of the robot 100 is formed of a synthetic resin as a main material. The robot 100 includes a body 101, a head 102 connected to an upper portion of the body 101, arms 103 connected to the left and right sides of the body 101, two legs 104 connected downwards from the body 101. The head 102 has a pair of left and right eyes 105, a mouth 106, and a pair of left and right ears 107. Note that the upper side, the lower side, the left side, and the right side in FIG. 2 are respectively the upper side, the lower side, the right side, and the left side of the robot 100.

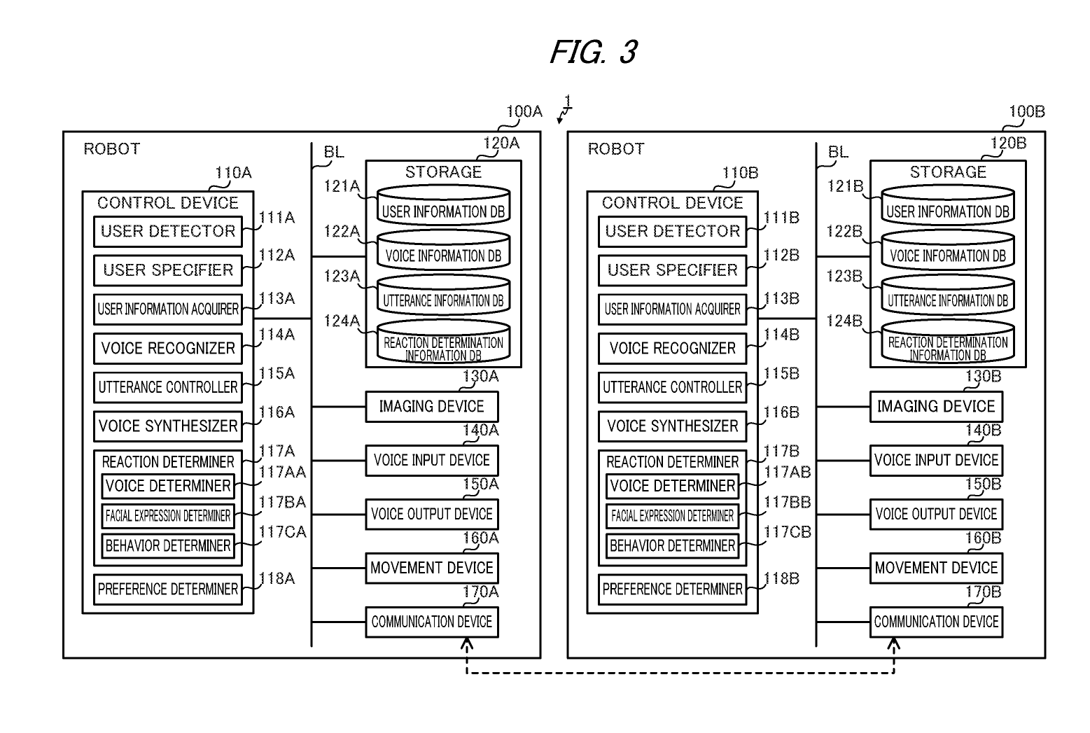

Next, the configuration of the robot 100 will be described with reference to FIG. 3. FIG. 3 shows a block diagram showing configurations of the robot 100A and the robot 100B, and the configuration of the robot 100A and the configuration of the robot 100B are the same. First, the configuration of the robot 100A will be described.

As shown in FIG. 3, the robot 100A includes a control device 110A, a storage 120A, an imaging device 130A, a voice input device 140A, a voice output device 150A, a movement device 160A, and a communication device 170A. These devices are mutually electrically connected via a bus line BL.

The control device 110A includes a computer including a central processing unit (CPU), a read only memory (ROM), and a random access memory (RAM), and controls the overall operation of the robot 100A. The control device 110A controls the operation of each device of the robot 100A by the CPU reading out a control program stored in the ROM and executing the program on the RAM.

The control device 110A functions as a user detector 111A, a user specifier 112A, a user information acquirer 113A, a voice recognizer 114A, an utterance controller 115A, a voice synthesizer 116A, a reaction determiner 117A, and a preference determiner 118A by executing a control program.

The user detector 111A detects a user USR present in the vicinity of the robot 100A (for example, within a range of a radius 2 m from the robot 100A). For example, the user detector 111A controls an imaging device 130A described below, images the periphery of the robot 100A, and detects the user USR present around the robot 100A in accordance with the detection of the movement of an object, a head, a face, and/or the like.

The user specifier 112A specifies the user USR detected by the user detector 111A. For example, the user specifier 112A extracts a facial image corresponding to the face of the user USR from an image captured by the imaging device 130A. Then, the user specifier 112A detects a feature quantity from the facial image, verifies the detected feature quantity against face information indicating a feature quantity of a face registered in a user information database of the storage 120A described below, calculates a similarity based on the verified result, and specifies the user USR according to whether or not the calculated similarity satisfies a predetermined criterion. In the user information database of the storage 120A, face information indicating feature quantities of faces of a predetermined plurality of users USR is stored. The user specifier 112A specifies which user USR among these users USR is the user USR detected by the user detector 111A. The feature quantity may be any information that can identify the user USR, and is information that numerically expresses appearance features such as the shape, size, arrangement, and the like of each part included in a face such as an eye, a nose, a mouth, or the like. In the following description, a user USR detected by the user detector 111A and specified by the user specifier 112A is referred to as a target user.

The user information acquirer 113A acquires user information indicating utterance, appearance, behavior, and/or the like of the target user. In the present embodiment, the user information acquirer 113A controls, for example, the imaging device 130A and the voice input device 140A to acquire, as user information, at least one of image information including image data of a captured image capturing a target user or voice information including voice data of a voice uttered by a target user.

The voice recognizer 114A performs voice recognition processing on the voice data included in the voice information acquired by the user information acquirer 113A so that the voice recognizer 114A converts the voice data into text data indicating utterance contents of the target user. For the voice recognition processing, for example, an acoustic model, a language model, and a word dictionary stored in a voice information database (DB) 122A of the storage 120A are used. For example, the voice recognizer 114A deletes background noise from the acquired voice data, identifies, with reference to an acoustic model, a phoneme included in the voice data from which the background noise has been deleted, and generates a plurality of conversion candidates by converting the identified phoneme string into a word with reference to a word dictionary. The voice recognizer 114A then refers to a language model, selects the most appropriate one among the generated plurality of conversion candidates, and outputs the candidate as text data corresponding to the voice data.

The utterance controller 115A controls utterance of the robot 100A. For example, the utterance controller 115A refers to utterance information stored in utterance information DB 123A of the storage 120A, and extracts a plurality of utterance candidates according to the situation from the utterance information stored in utterance information DB 123A. Then, the utterance controller 115A refers to preference information included in user information stored in the user information DB 121A, selects an utterance candidate conforming to the preference of the target user from the plurality of extracted utterance candidates, and determines the candidate as utterance contents of the robot 100A. The utterance controller 115A thus functions as an utterance controller.

The utterance controller 115A communicates with a robot 100B via the communication device 170A, cooperates with an utterance controller 115B of the robot 100B, and adjusts and determines utterance contents of the robot 100A as follows.

Specifically, the utterance controller 115A cooperates with the utterance controller 115B of the robot 100B, and for example, acquires elapsed time since the robot 100B uttered, and in cases in which the robot 100A utters when the acquired elapsed time is within a predetermined elapsed time (for example, 72 hours), the topic of utterance of the robot 100A is adjusted in such a manner that the topic uttered by the robot 100A is different from the topic uttered by the robot 100B within the predetermined elapsed time before the start of utterance by the robot 100A, and the utterance contents are determined. Such determination of a topic is similarly performed also in the utterance controller 115B of the robot 100B. As described above, topics uttered by the robot 100A and the robot 100B are determined as topics different from each other, and utterances of both robots 100A and 100B are controlled with the determined topics.

As will be described below, each of the robot 100A and the robot 100B determines a reaction of the target user to its own utterance, and collects (stores) the preference information of the target user based on the determination result, and in this case, when topics uttered by the robot 100A and the robot 100B overlap or are always related to each other, no new preference information or preference information of a wider field of the target user can be collected. The target user also feels annoyed by being heard duplicate topic utterances. By determining topics of utterances of the robot 100A and the robot 100B as topics different from each other, it is possible to collect more various types of preference information.

On the other hand, when the predetermined elapsed time has elapsed since the robot 100B uttered, the utterance controller 115A independently determines the utterance contents without being limited by the utterance contents of the robot 100B. In other words, topics (utterance contents) uttered by the robots 100A and 100B are determined irrespectively of each other (independently of each other) without cooperating with each other.

The utterance controller 115A generates and outputs text data indicating its own utterance contents determined in cooperation with the robot 100B.

The voice synthesizer 116A generates voice data corresponding to text data indicating utterance contents of the robot 100A input from the voice controller 115A. The voice synthesizer 116A generates voice data for reading out a character string indicated by the text data, for example, using an acoustic model and the like stored in the voice information DB 122A of the storage 120A. The voice synthesizer 116A controls a voice output device 150A to output generated voice data as a voice.

The reaction determiner 117A determines a reaction of the target user to an utterance of the robot 100A. As a result, a reaction to an utterance of the robot 100A is determined for each target user specified by the user specifier 112A among the predetermined plurality of users USR. The reaction determiner 117A includes a voice determiner 117AA, a facial expression determiner 117BA, and a behavior determiner 117CA. The voice determiner 117AA, the facial expression determiner 117BA, and the behavior determiner 117CA determine a reaction to an utterance of the target robot 100A, based on a voice, an expression, and a behavior of a target user, respectively, by classifying into three polarities. The three polarities are “Positive” which is a positive reaction, “Negative” which is a negative reaction, and “Neutral” which is a neutral reaction that is neither positive nor negative.

The voice determiner 117AA determines a reaction of a target user to an utterance of the robot 100A based on a voice uttered by the target user after utterance of the robot 100A. The voice determiner 117AA determines a reaction of a target user to the utterance of the robot 100A by classifying utterance contents of the target user into three voice reaction polarities “Positive”, “Negative”, and “Neutral” based on text data generated by the voice recognizer 114A performing voice recognition processing on a voice acquired by the user information acquirer 113A after utterance of the robot 100A. The voice determiner 117 AA thus has a voice determination function.

The facial expression determiner 117 BA determines a reaction of the target user to an utterance of the robot 100A based on a facial expression of the target user after utterance of the robot 100A. The facial expression determiner 117BA calculates a smile level indicating the smile level as an index for evaluating a facial expression of a target user. The facial expression determiner 117BA extracts a facial image of the target user from a captured image acquired by the user information acquirer 113A after utterance of the robot 100A, and detects a feature quantity of the face of the target user. The facial expression determiner 117BA refers to smile level information stored in the reaction determination information DB 124A of the storage 120A, and calculates a smile level of the target user based on the detected feature quantity. The facial expression determiner 117BA determines a reaction of the target user to the utterance of the robot 100A by classifying the facial expression of the target user into three facial expression reaction polarities “Positive”, “Negative”, and “Neutral” according to the calculated smile level. As described above, the facial expression determiner 117BA thus has a facial expression determination function.

The behavior determiner 117CA determines a reaction of a target user to an utterance of the robot 100A based on a behavior of the target user after utterance of the robot 100A. The behavior determiner 117CA detects the behavior of the target user from a captured image acquired by the user information acquirer 113A after utterance of the robot 100A. The behavior determiner 117CA determines a reaction of the target user to the utterance of the robot 100A by classifying the behavior of the target user into three behavior reaction polarities “Positive”, “Negative”, and “Neutral”. The behavior determiner 117CA thus has a behavior determination function.

The preference determiner 118A specifies a topic in a dialogue between the target user and the robot 100A, and determines a preference degree indicating the height of the target user's preferences for the specified topic based on each determination result by the reaction determiner 117A. As a result, for each target user specified by the user specifier 112A among the predetermined plurality of users USR, the preference degree is determined. Here, the preference is an interest or a preference relating to various things regardless of whether the things are tangible or intangible, including, for example, interests or preferences relating to food, sports, weather, and the like, and preferences for reactions (utterance contents) of the robot 100. The preference determiner 118A classifies the preference degree into four stages of “preference degree A”, “preference degree B”, “preference degree C.”, and “preference degree D” in descending order of preference of the target user for a topic.

Each function of the user detector 111A, the user specifier 112A, the user information acquirer 113A, the voice recognizer 114A, the utterance controller 115A, the voice synthesizer 116A, the reaction determiner 117A, and the preference determiner 118A may be realized by a single computer, or may be realized by a separate computer.

The storage 120A includes a rewritable nonvolatile semiconductor memory, a hard disk drive, and/or the like, and stores various data necessary for the control device 110A to control each device of the robot 100A.

The storage 120A includes a plurality of databases each storing various data. The storage 120A includes, for example, a user information DB 121A, a voice information DB 122A, an utterance information DB 123A, and a reaction determination information DB 124A. Utterance history information including utterance date and time of the robot 100A, an uttered topic, and the like is stored in the storage 120A for each user USR.

The user information DB 121A accumulates and stores various pieces of information on each of a plurality of registered users USR as user information. The user information includes, for example, user identification information (for example, an ID of a user USR) allocated to identify each of the plurality of users USR in advance, face information indicating a feature quantity of the face of the user USR, and preference information indicating a preference degree of the user USR for each topic. By thus using user identification information, preference information of each of the plurality of users USR is stored in such a manner that it is possible to identify which user USR the information belongs to.

The voice information DB 122A stores, for example, an acoustic model representing each feature (frequency characteristic) of a phoneme which is the smallest unit of sound making one word different from another word, a word dictionary that associates features of phonemes with words, and a language model representing a sequence of words and conjunctive probabilities therebetween as data used for voice recognition processing or voice synthesis processing.

The utterance information DB 123A stores utterance information indicating utterance candidates of the robot 100A. The utterance information includes various utterance candidates in accordance with a situation of a dialogue with a target user, for example, an utterance candidate in the case of talking to the target user, an utterance candidate in the case of responding to an utterance of the target user, an utterance candidate in the case of talking with the robot 100B or the like.

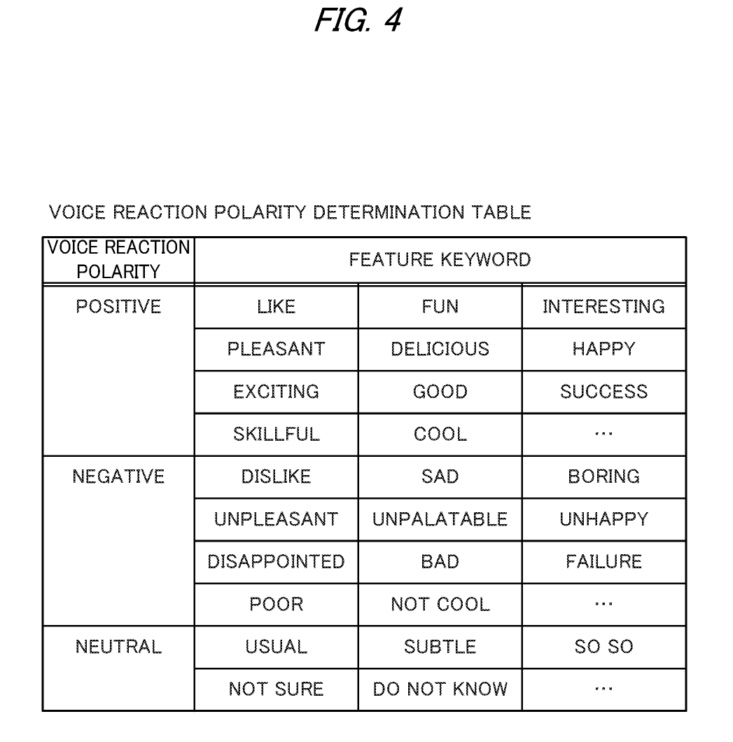

The reaction determination information DB 124A stores reaction determination information used when the reaction determiner 117A determines a reaction of the target user to an utterance of the robot 100A. The reaction determination information DB 124A stores, for example, voice determination information used when the voice determiner 117AA of the reaction determiner 117A determines a reaction of the target user to an utterance of the robot 100A as reaction determination information. The voice determination information is stored, for example, in the form of a voice reaction polarity determination table shown in FIG. 4. In the voice reaction polarity determination table, a voice response polarity and a feature keyword described below are associated with each other. The reaction determination information DB 124A stores, for example, smile level information used when the facial expression determiner 117BA of the reaction determiner 117A calculates the smile level of the target user as reaction determination information. The smile level information is information obtained by quantifying a smile level in the range of from 0 to 100% according to the degree of change in the position of an outer canthus or a corner of a mouth, the size of an eye or mouth, and/or the like, for example.

The imaging device 130A comprises a camera including an imaging element such as a lens, a charge coupled device (CCD) image sensor, and a complementary metal oxide semiconductor (CMOS) image sensor, and images surroundings of the robot 100A. The imaging device 130A is provided, for example, on a front upper portion of the head 102, captures an image in front of the head 102, and generates and outputs digital image data. The camera is attached to a motor-driven frame (gimbal or the like) operable to change the direction in which a lens faces, and is configured to be able to track the face of the user USR.

The voice input device 140A comprises a microphone, an analog to digital (A/D) converter, and the like, amplifies a voice collected by a microphone installed, for example, in an ear 107, and outputs digital voice data (voice information) subjected to signal processing such as A/D conversion and encoding to the control device 110A.

The voice output device 150A comprises a speaker, a digital to analog (D/A) converter, and the like, performs signal processing such as decoding, D/A conversion, amplification, and the like on sound data supplied from the voice synthesizer 116A of the control device 110A, and outputs an analog voice signal from, for example, a speaker installed in the mouth 106.

The robot 100A collects a voice of the target user with the microphone of the voice input device 140A, and outputs a voice corresponding to utterance contents of the target user from the speaker of the voice output device 150A under the control of the control device 110A, thereby communicating with the target user by a dialogue. The robot 100A thus functions as a first utterance device.

The movement device 160A is a portion for moving the robot 100A. The movement device 160A includes wheels provided at the bottom of the left and right feet 104 of the robot 100A, a motor for rotating the left and right wheels, and a drive circuit for driving and controlling the motor. In accordance with a control signal received from the control device 110A, the drive circuit supplies a drive pulse signal to the motor. The motor drives the left and right wheels to rotate in accordance with a drive pulse signal, and moves the robot 100A. Note that the number of motors is any as long as the left and right wheels are configured to independently rotate, and the robot 100A can travel forward, backward, turn, accelerate and decelerate. The right and left wheels may be driven by one motor by providing a coupling mechanism or a steering mechanism, for example. The number of drive circuits can be appropriately changed according to the number of motors.

The communication device 170A comprises a wireless communication module and an antenna for communicating using a wireless communication method, and performs wireless data communication with the robot 100B. As the wireless communication method, for example, a short range wireless communication method such as Bluetooth (registered trademark), Bluetooth Low Energy (BLE), ZigBee (registered trademark), or infrared communication and a wireless LAN communication method such as wireless fidelity (Wi-Fi) can be employed as appropriate. In the present embodiment, the robot 100A performs wireless data communication with the robot 100B via the communication device 170A, whereby the robot 100A and the robot 100B have a dialogue with the target user.

Since the robot 100B is similar to the robot 100A, the configuration will be briefly described. Like the robot 100A, the robot 100B includes a control device 110B, a storage 120B, an imaging device 130B, a voice input device 140B, a voice output device 150B, a movement device 160B, and a communication device 170B. The control device 110B controls the entire action of the robot 100B, and functions as a user detector 111B, a user specifier 112B, a user information acquirer 113B, a voice recognizer 114B, an utterance controller 115B, a voice synthesizer 116B, a reaction determiner 117B, and a preference determiner 118B by executing a control program. The utterance controller 115B refers to preference information included in user information stored in the user information DB 121B, selects an utterance candidate conforming to the preference of a target user from the plurality of extracted utterance candidates, and determines the utterance candidate as utterance contents of the robot 100B. The utterance controller 115B communicates with a robot 100A via the communication device 170B, cooperates with an utterance controller 115A of the robot 100A, and for example, acquires elapsed time since the robot 100A uttered. When the acquired elapsed time is within the predetermined elapsed time, the utterance controller 115B adjusts utterance contents of the robot 100B in such a manner that the topic uttered by the robot 100B is different from the topic uttered by the robot 100A within the predetermined elapsed time before the start of utterance by the robot 100B, and the utterance contents are determined. The reaction determiner 117B determines a reaction of the target user to an utterance of the robot 100B. The reaction determiner 117B includes a voice determiner 117AB, a facial expression determiner 117BB, and a behavior determiner 117CB. The voice determiner 117AB determines a reaction to an utterance of the target robot 100B by classifying into three polarities of “Positive”, “Negative”, and “Neutral” based on a voice of a target user. The facial expression determiner 117BB determines a reaction to an utterance of the target robot 100B by classifying into three polarities of “Positive”, “Negative”, and “Neutral” based on an expression. The behavior determiner 117CB determines a reaction to an utterance of the target robot 100B by classifying into three polarities of “Positive”, “Negative”, and “Neutral” based on a behavior of a target user. The storage 120B includes a plurality of databases each storing various data. The storage 120B includes, for example, a user information DB 121B, a voice information DB 122B, an utterance information DB 123B, and a reaction determination information DB 124B. Utterance history information including utterance date and time of the robot 100B, an uttered topic, and the like is stored in the storage 120B for each user USR. The robot 100B collects a voice of the target user with the microphone of the voice input device 140B, and outputs a voice corresponding to utterance contents of the target user from the speaker of the voice output device 150B under the control of the control device 110B, thereby communicating with the target user by a dialogue. The robot 100B thus functions as a second utterance device.

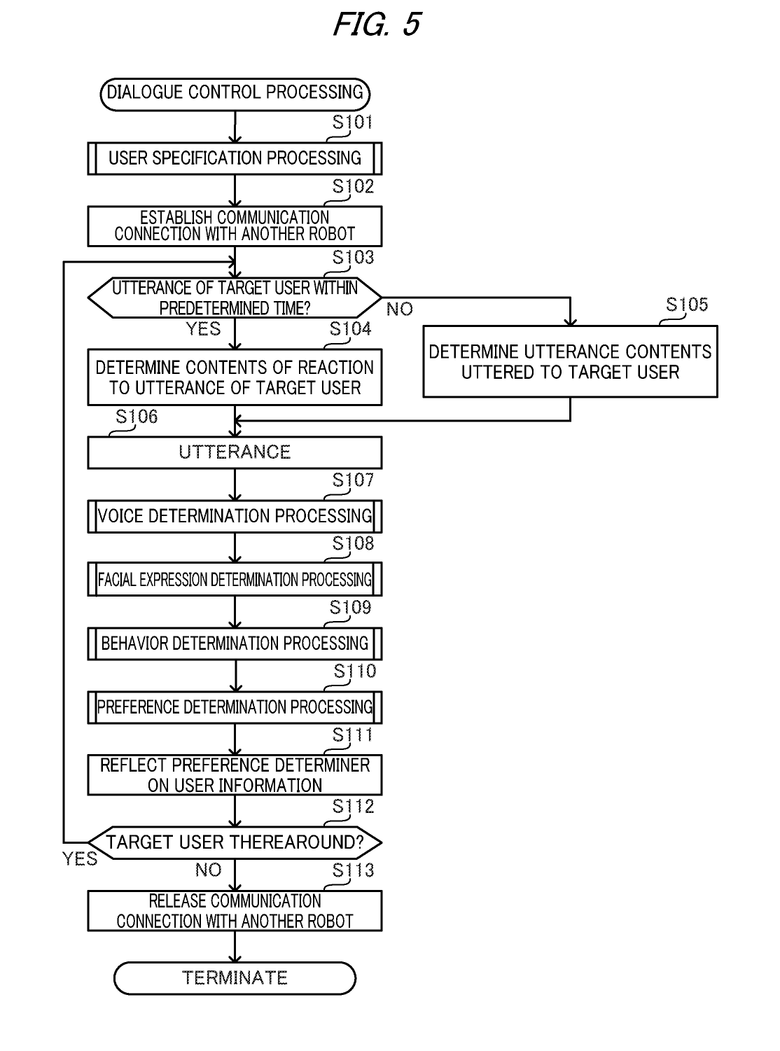

Next, dialogue control processing executed by the robot 100 will be described with reference to the flowchart shown in FIG. 5. Dialogue control processing is a process of controlling a dialogue in accordance with a preference of the target user. Here, dialogue control processing will be described by taking a case in which such processing is executed by the control device 110A of the robot 100A. The control device 110A starts dialogue control processing at a moment when the user detector 111A detects the user USR around the robot 100A.

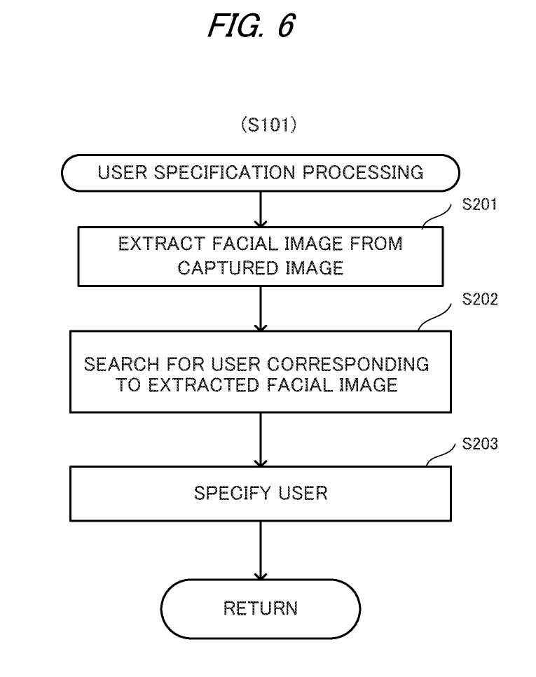

Upon starting the dialogue control process, the control device 110A firstly executes user specification processing (step S101). Here, with reference to the flowchart shown in FIG. 6, the user specification processing will be described. The user specification processing is a process of specifying a user present around the robot 100A detected by the user detector 111A.

Upon starting user specification processing, the control device 110A firstly extracts a facial image of the target user from a captured image acquired from the imaging device 130A (step S201). For example, the control device 110A (the user specifier 112A) detects a flesh color area in a captured image, determines whether or not there is a portion corresponding to a face part such as an eye, nose, or mouth in the flesh color area, and when it is determined that there is a portion corresponding to a face part, the flesh color area is regarded as a facial image and the area is extracted.

Subsequently, the control device 110A searches for a registered user corresponding to the extracted facial image (step S202). The control device 110A (user specifier 112A) detects a feature quantity from the extracted facial image, verifies the extracted facial image against face information stored in the user information DB 121A of the storage 120A, and searches for a registered user whose similarity is equal to or greater than a predetermined criterion.

In accordance with the search result in step S202, the control device 110A specifies the user USR present around the robot 100 (step S203). For example, the control device 110A (the user specifier 112A) specifies the user USR corresponding to a feature quantity having the highest similarity to the feature quantity detected from the facial image among the feature quantities of the faces of the plurality of users USR stored in the user information DB 121A as the target user present around the robot 100A.

After executing processing of step S203, the control device 110A terminates the user specification processing, and returns the processing to the dialogue control processing.

Returning to FIG. 5, after executing the user specification processing (step S101), the control device 110A establishes a communication connection with the robot 100B (another robot) (step S102). Establishing a communication connection herein means establishing a state in which it is possible to transmit and receive data to each other by performing a predetermined procedure by designating a communication partner. The control device 110A controls the communication device 170A to establish a communication connection with the robot 100B by performing a predetermined procedure depending on a communication method. When the robot 100A and the robot 100B perform data communication using an infrared communication method, it is not necessary to establish a communication connection in advance.

Subsequently, the control device 110A determines whether or not the target user specified in step S101 has uttered within a predetermined time shorter than the predetermined elapsed time (for example, within 20 seconds) (step S103). For example, the control device 110A measures an elapsed time from the start of execution of the processing using current time information measured by a real time clock (RTC) attached to a CPU, and determines the presence/absence of an utterance of the target user within the predetermined time based on voice information acquired by the user information acquirer 113A.

When it is determined that the target user uttered within the predetermined time (step S103: YES), the control device 110A (utterance controller 115A) determines that a dialogue with the target user is being executed, and determines contents of an utterance as a reaction to the utterance of the target user in cooperation with the robot 100B (step S104). The control device 110A (utterance controller 115A) refers to the utterance information DB 123A and the user information DB 121A of the storage 120A, and determines a topic candidate corresponding to utterance contents of the target user and conforming preference of the target user stored in the user information DB 121A. In this case, as topic candidates conforming to the preference of the target user, topics corresponding to preference degrees A and B, which will be described below, are determined.

In this step S104, when only one topic candidate is determined, the candidate is determined as the final topic. On the other hand, in cases in which a plurality of topic candidates is determined, when utterance history information is stored in the storage 120B of the robot 100B, the control device 110A (utterance controller 115A) reads the utterance history information stored in the storage 120B via the communication device 170A, and determines whether or not a topic (hereinafter referred to as “first comparative topic”) that is the same as or related to any one of a plurality of topic candidates and whose elapsed time from the utterance date and time to the present (the start time of uttering of the robot 100A) is within the predetermined elapsed time is present in the read utterance history information.

Then, when the control device 110A (utterance controller 115A) determines that the first comparative topic is present in the utterance history information, the device excludes those matched or related to the first comparative topic from candidates of a plurality of topics, and eventually determines a topic. In cases in which there are a plurality of candidates of topics left by this exclusion, one topic randomly selected from the candidates is determined as an eventual topic.

On the other hand, in cases in which a plurality of topic candidates is determined, when no utterance history information is stored in the storage 120B of the robot 100B or when it is determined that first comparative topic is not present in the utterance history information, one topic randomly selected from the determined plurality of topic candidates is determined as an eventual topic. The utterance controller 115A outputs text data indicating utterance contents conforming to the topic determined as described above.

On the other hand, when it is determined that the target user did not utter within the predetermined time (step S103: NO), the control device 110A (utterance controller 115A) determines an utterance topic to be uttered to the target user (step S105). At this time, the control device 110A (utterance controller 115A) refers to the utterance information DB 123A and the user information DB 121A of the storage 120A, and determines a plurality of topic candidates conforming to the preference of the target user stored in the user information DB 121A. In this case, as a topic candidate conforming to the preference of the target user, a topic corresponding to preference degrees A and B, which will be described below, are determined.

In step S105, when there is only one topic candidate determined, the candidate is determined as an eventual topic. On the other hand, when a plurality of topic candidates is determined, as in the case of step S104, an eventual topic is selected from the plurality of topic candidates. Specifically, in cases in which a plurality of topic candidates is determined, when utterance history information is stored in the storage 120B of the robot 100B, the control device 110A (utterance controller 115A) reads utterance history information stored in the storage 120B via the communication device 170A, and determines whether or not the first comparative topic is present in the read utterance history information.

When the control device 110A (utterance controller 115A) determines that the first comparative topic is in the utterance history information, the control device 110A (utterance controller 115A) excludes those matched or related to the first comparative topic from a plurality of topic candidates, and eventually determines a topic. When there is a plurality of topic candidates left by this exclusion, one topic randomly selected from the candidates is determined as an eventual topic.

On the other hand, in cases in which a plurality of topic candidates is determined, when no utterance history information is stored in the storage 120B of the robot 100B or when it is determined that the first comparative topic is not present in the utterance history information, one topic randomly selected from the determined plurality of topic candidates is determined as an eventual topic.

An action of talking to the target user when the target user has not uttered within the predetermined time is a trigger of a dialogue between the target user and the robot 100A and the robot 100B, and is performed in order to urge the target user to use the dialogue system 1.

After executing step S104 or step S105, the control device 110A utters based on utterance contents conforming to a determined topic (step S106). The control device 110A (the voice synthesizer 116A) generates voice data corresponding to text data indicating the utterance contents of the robot 100A input from the utterance controller 115A, controls the voice output device 150A, and outputs a voice based on the voice data.

Steps S107 to S109 are processing for determining a reaction of the target user to the utterance of the robot 100A in step S106.

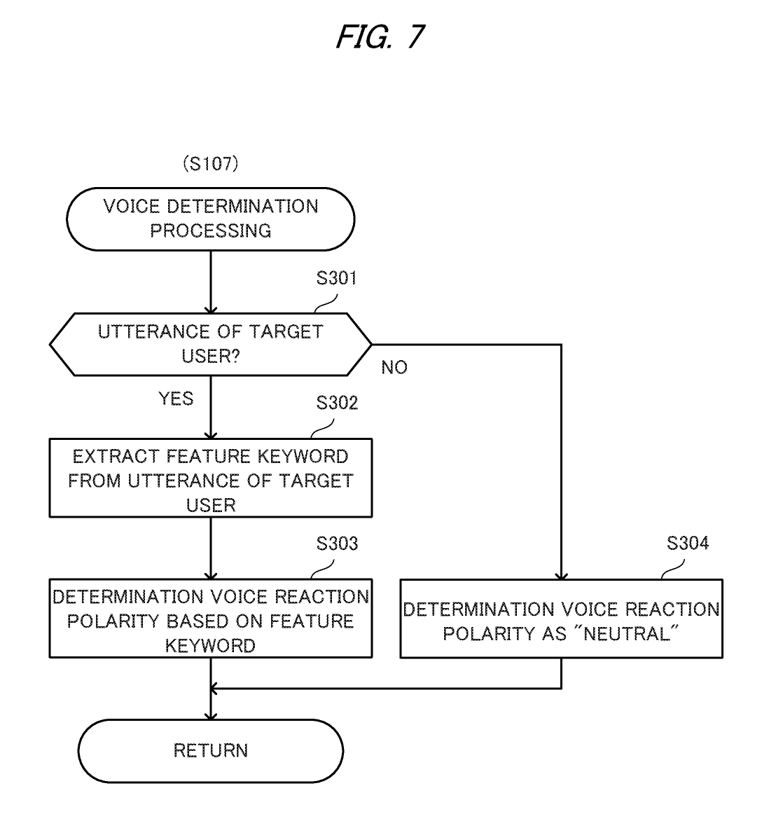

First, the control device 110A (voice determiner 117AA of the reaction determiner 117A) executes voice determination processing (step S107). Here, the voice determination processing will be described with reference to the flowchart shown in FIG. 7. The voice determination processing is processing of determining a reaction of the target user to the utterance of the robot 100A based on the voice generated from the target user after the utterance of the robot 100A.

Upon starting the voice determination processing, the voice determiner 117AA firstly determines whether the target user has uttered or not after the utterance of the robot 100A in step S106 (step S301). The control device 110A determines the presence or absence of an utterance of the target user to the utterance of the robot 100A based on the voice information acquired by the user information acquirer 113A after the utterance of the robot 100A.

When it is determined that the target user has uttered after the utterance of the robot 100A (step S301: YES), the voice determiner 117AA extracts a feature keyword from the utterance of the target user to the utterance of the robot 100A (step S302). The voice determiner 117AA extracts a keyword related to emotion as a feature keyword characterizing utterance contents of the target user based on text data indicating utterance contents of the target user generated by the voice recognizer 114.

Subsequently, the voice determiner 117AA determines a voice reaction polarity based on the feature keyword (step S303). For example, the sound determiner 117AA refers to the voice reaction polarity determination table shown in FIG. 4 stored as reaction determination information in the reaction determination information DB 124A of the storage 120A, and the determination is made according to a voice reaction polarity associated with the extracted feature keyword. For example, when the feature keyword is “like”, “fun”, or the like, the voice determiner 117AA determines that the voice reaction polarity is “Positive”.

On the other hand, when it is determined that there is no utterance of the target user after utterance of the robot 100A (step S301: NO), since a response of the target user to the utterance of the robot 100A is unknown, the voice determiner 117AA determines that the voice reaction polarity is “Neutral” (step S304).

After executing step S303 or S304, the control device 110 terminates the voice determination processing, and returns the processing to dialogue control processing.

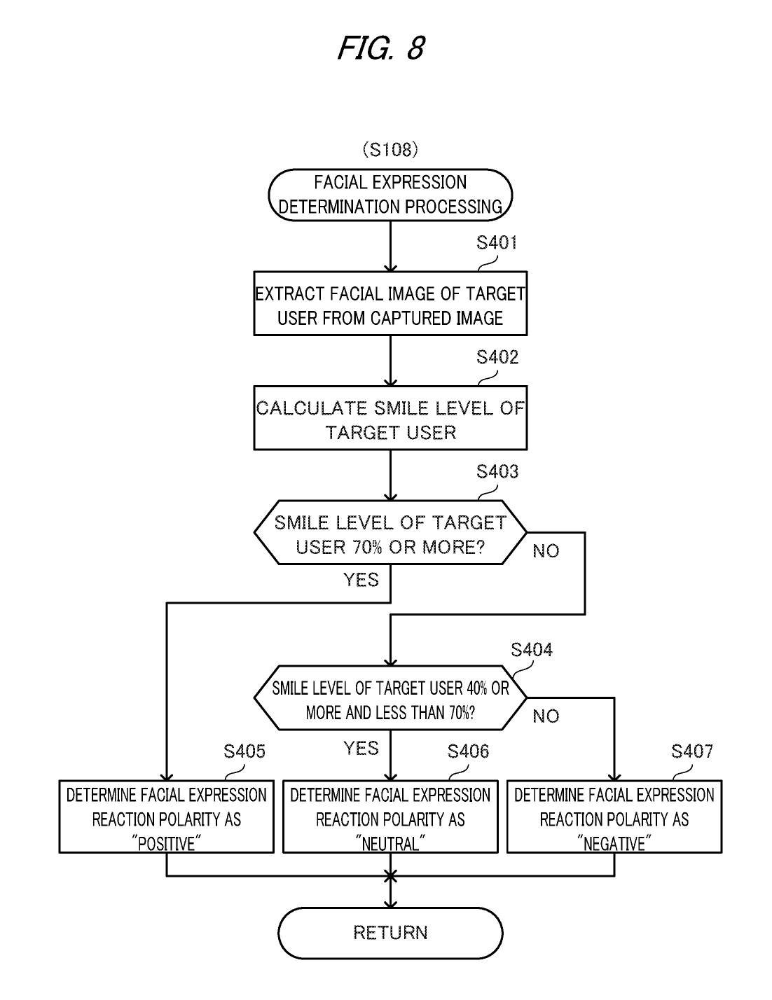

Returning to FIG. 5, after executing voice determination processing (step S107), the control device 110A (facial expression determiner 117BA of the reaction determiner 117) executes facial expression determination processing (step S108). Here, the facial expression determination processing will be described with reference to the flowchart shown in FIG. 8. The facial expression determination processing is processing of determining a reaction of a target user to an utterance of the robot 100A based on a facial expression of the target user.

Upon starting facial expression determination processing, the control device 110A (facial expression determiner 117BA of the reaction determiner 117A) firstly extracts a facial image of the target user from the captured image acquired by the user information acquirer 113A after the utterance in step S106 of the robot 100A (step S401).

Subsequently, the facial expression determiner 117BA calculates a smile level of the target user based on the facial image extracted in step S401 (step S402). For example, the control device 110 refers to smile level information stored in the reaction determination information DB 124A, and calculates the smile level of the target user in the range of from 0 to 100% based on change in the position of an outer canthus of the facial image, change in the size of the mouth, or the like.

Next, the facial expression determiner 117BA determines whether or not the smile level of the target user calculated in step S402 is 70% or more (step S403). When the smile level of the target user is 70% or more (step S403: YES), the control device 110 determines that the facial expression reaction polarity is “Positive” (step S405).

When the smile level of the target user is not 70% or more (step S403: NO), the control device 110A determines whether or not the smile level of the target user is 40% or more and less than 70% (step S404). When the smile level of the target user is 40% or more and less than 70% (step S404: YES), the control device 110 determines that the facial expression reaction polarity is “Neutral” (step S406).

When the smile level of the target user is not 40% or more and less than 70% (step S404: NO), that is to say when the smile level of the target user is less than 40%, the control device 110 determines that the facial expression reaction polarity is “Negative” (step S407).

After determining the facial expression reaction polarity of the target user in one of steps S405 to S407, the control device 110A terminates the facial expression determination processing, and returns the processing to dialogue control processing.

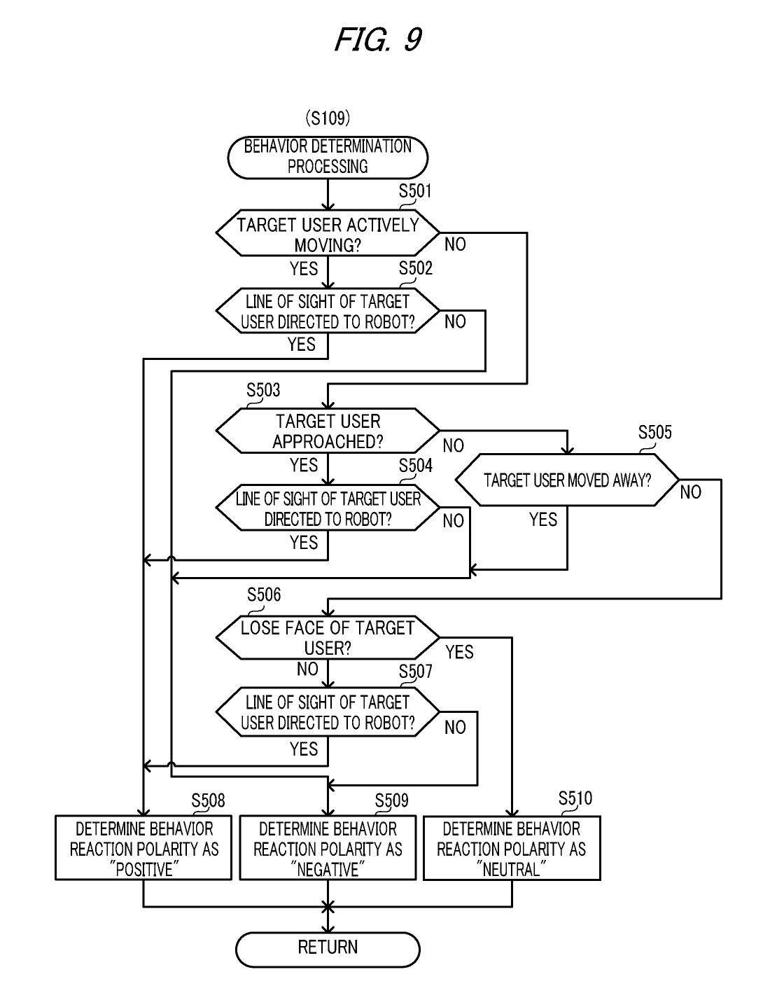

Returning to FIG. 5, after executing facial expression determination processing (step S108), the control device 110A executes behavior determination processing (step S109). Here, with reference to the flowchart shown in FIG. 9, the behavior determination processing will be described. The behavior determination processing is processing of determining a reaction of the target user to an utterance of the robot 100A based on a behavior of the target user.

Upon starting the behavior determination processing, the control device 110A (behavior determiner 117CA of the reaction determiner 117A) firstly determines whether or not the target user is actively moving (step S501). The determination of the behavior determiner 117 CA is based on a movement of the target user in the captured image acquired by the user information acquirer 113A after utterance of the robot 100A in step S106. When it is determined that the target user is actively moving (step S501: YES), the behavior determiner 117CA determines whether or not the line of sight of the target user is directed to the robot 100A (step S502). The determination of the behavior determiner 117CA is made, for example, by specifying the direction of the line of sight of the target user from the position of the pupil in an eye area in the captured image acquired by the user information acquirer 113A, the orientation of the face, and the like.

When it is determined that the line of sight of the target user faces the robot 100A (step S502: YES), the behavior determiner 117CA determines that the behavior reaction polarity is “Positive” (step S508). On the other hand, when it is determined that the line of sight of the target user is not directed to the robot 100A (step S502: NO), the behavior determiner 117CA determines that the behavior reaction polarity is “Negative” (step S509).

In step S501, when it is determined that the target user is not actively moving (step S501: NO), the behavior determiner 117CA determines whether or not the target user approaches the robot 100A (step S503). The determination of the behavior determiner 117CA is made, for example, according to change in the size of the facial image in the captured image acquired by the user information acquirer 113A.

When it is determined that the target user has approached the robot 100A (step S503: YES), the behavior determiner 117CA determines whether or not the line of sight of the target user is directed to the robot 100A (step S504). When it is determined that the line of sight of the target user is directed to the robot 100A (step S504: YES), the behavior determiner 117CA determines that the behavior reaction polarity is “Positive” (step S508). On the other hand, when it is determined that the line of sight of the target user is not directed to the robot 100A (step S504: NO), the behavior determiner 117CA determines that the behavior reaction polarity is “Negative” (step S509).

When it is determined in step S503 that the target user is not approaching the robot 100A (step S503: NO), the behavior determiner 117CA determines whether or not the target user has moved away from the robot 100A (step S505). When it is determined that the target user has moved away from the robot 100A (step S505: YES), the behavior determiner 117CA determines that the behavior reaction polarity is “Negative” (step S509).

On the other hand, when it is determined that the target user is not moving away from the robot 100A (step S505: NO), the behavior determiner 117C determines whether or not the face of the target user has been lost (step S506). When the facial image of the target user cannot be extracted from the captured image due to the reversal of the face direction of the target user or the like, the behavior determiner 117CA determines that the face portion of the target user has been lost. When it is determined that the face portion of the target user has been lost (step S506: YES), the behavior determiner 117 CA determines that the behavior reaction polarity is “Neutral” (step S510).

When it is determined that the face portion of the target user has not been lost (step S506: NO), the behavior determiner 117CA determines whether or not the line of sight of the target user is directed to the robot 100A (step S507). When it is determined that the line of sight of the target user is directed to the robot 100A (step S507: YES), the behavior determiner 117CA determines that the behavior reaction polarity is “Positive” (step S508). On the other hand, when it is determined that the line of sight of the target user is not directed to the robot 100A (step S507: NO), the behavior determiner 117CA determines that the behavior reaction polarity is “Negative” (step S509).

After determining the behavior reaction polarity of the target user in any one of steps S508 to S510, the control device 110 terminates the behavior determination processing, and returns the processing to dialogue control processing.

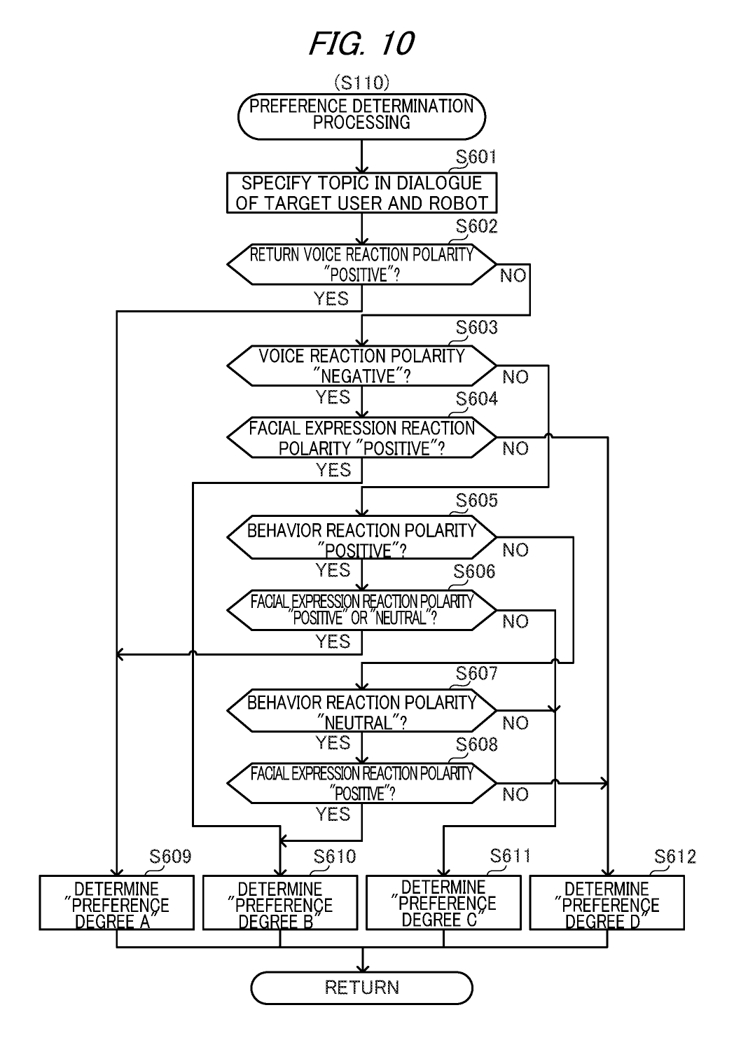

Returning to FIG. 5, after executing behavior determination processing (step S109), the control device 110A (preference determiner 118A) executes preference determination processing (step S110). Here, with reference to the flowchart shown in FIG. 10, the preference determination processing will be described. The preference determination processing comprehensively determines the preference level of the target user with respect to a topic in a dialogue between the target user and the robot 100A by using determination results of voice determination processing, facial expression determination processing, and behavior determination processing.

Upon starting preference determination processing, the preference determiner 118A firstly specifies a topic in a dialogue between the target user and the robot 100A (step S601). In step S105 of dialogue control processing, when speaking to the target user when the target user has not uttered for a predetermined time, and when a topic is preset, the preference determiner 118A refers to topic keywords stored in RAM or the like, and specifies a topic in a dialogue between the target user and the robot 100A. On the other hand, when no topic is set in advance, the preference determiner 118A specifies a topic in a dialogue between the target user and the robot 100A by extracting a topic keyword from an utterance of the target user based on text data indicating utterance contents of the target user generated by the voice recognizer 114A. For example, from an utterance of the target user “like baseball”, a topic “baseball” is specified.

Next, the preference determiner 118A determines whether or not the voice reaction polarity determined in the voice determination processing of FIG. 7 is “Positive” (step S602), and when the voice reaction polarity is “Positive” (step S602: YES), the preference degree is determined to be “preference degree A” (step S609).

When the voice reaction polarity is not “Positive” (step S602: NO), the preference determiner 118 A determines whether or not the voice reaction polarity is “Negative” (step S603). When the voice reaction polarity is “Negative” (step S603: YES), the preference determiner 118A determines whether or not the facial expression reaction polarity determined in the facial expression determination processing of FIG. 8 is “Positive” (step S604). When the facial expression reaction polarity is “Positive” (step S604: YES), the preference determiner 118A determines that the preference degree is “Preference degree B” (step S610). On the other hand, when the facial expression reaction polarity is not “Positive” (step S604: NO), the preference determiner 118A determines that the preference degree is “Preference degree D” (step S612).

In step S603, when the voice reaction polarity is not “Negative” (step S603: NO), the preference determiner 118A determines whether or not the behavior reaction polarity determined in the behavior determination processing of FIG. 9 is “Positive” (step S605). When the behavior reaction polarity is “Positive” (step S605: YES), the preference determiner 118A determines whether or not the facial expression reaction polarity is either “Positive” or “Neutral” (step S606). When the facial expression reaction polarity is either “Positive” or “Neutral” (step S606: YES), the preference determiner 118A determines that the preference degree is “Preference degree A” (step S609). On the other hand, when the facial expression reaction polarity is neither “Positive” nor “Neutral” (step S606: NO), that is to say when the facial expression reaction polarity is “Negative”, the preference determiner 118A determines that the preference degree is “Preference degree C.” (step S611).

In step S605, when the behavior reaction polarity is not “Positive” (step S605: NO), the preference determiner 118A determines whether or not the behavior reaction polarity is “Neutral” (step S607), and when the behavior reaction polarity is not “Neutral” (step S607: NO), the preference determiner 118A determines that the preference degree is “Preference degree C.” (step S611).

On the other hand, when the behavior reaction polarity is “Neutral” (step S607: YES), the preference determiner 118A determines whether or not the facial expression reaction polarity is “Positive” (step S608). When the facial expression reaction polarity is “Positive” (step S608: YES), the preference determiner 118A determines that the preference degree is “Preference degree B” (step S610), and when the facial expression reaction polarity is not “Positive” (step S608: NO), the preference determiner 118A determines that the preference degree is “Preference degree D” (step S612).

After determining the preference degree of the target user in any one of steps S609 to S612, the preference determiner 118A terminates the preference determination processing, and returns the processing to dialogue control processing.

Returning to FIG. 5, after executing the preference determination processing (step S110), the control device 110A reflects the preference determination result on preference degree information (step S111). The control device 110A adds information in which topics and preference degrees in the dialogue between the target user and the robot 100A are associated with each other as the preference determination result in the preference determination processing to the preference degree information of the user information stored in the user information DB 121A, and updates the preference degree information. As a result, the preference degree information is updated for each user USR. The topic in a dialogue between the target user and the robot 100A is a topic indicated by a topic keyword stored in a RAM or the like. The control device 110A controls the communication device 170A, and transmits information in which topics and preference degrees in a dialogue between the target user and the robot 100A are associated with each other to the robot 100B. Likewise, the robot 100B having received this information adds this information to the preference degree information of the user information stored in the user information DB 121B, and updates the preference degree information. As a result, the robot 100A and the robot 100B can share the preference determination results thereof. The initial value of the preference degree included in the preference degree information stored in association with each of a plurality of topics is set as Preference degree A. As described above, the control device 110A (110B) including the reaction determiner 117A (117B) and the preference determiner 118A (118B) and the communication device 170A (170B) function as a reaction acquirer.

After executing the processing of step S111, the control device 110A determines whether or not the target user is present around the robot 100A (step S112). When it is determined that the target user is present around the robot 100A (step S112: YES), the control device 110A determines that a dialogue with the target user can be continued, and returns the processing to step S103. In step S103 in the case of YES in step S112, whether or not the elapsed time from completion of utterance in step S106 is within the predetermined time is determined.

On the other hand, when it is determined that the target user is not present around the robot 100A (step S112: NO), the control device 110A determines that a dialogue with the target user cannot be continued, and cancels the communication connection with the robot 100B (another robot) (step S113). By controlling the communication device 170A and executing a predetermined procedure based on a communication method, the control device 110A cancels the communication connection with the robot 100B. After that, the control device 110A terminates the dialogue control processing.

The above is the dialogue control processing executed by the control device 110A of the robot 100A, and dialogue control processing executed by the control device 110B of the robot 100B is the same. As shown in FIG. 5, the control device 110B starts dialogue control processing. User specification processing is executed as shown in FIG. 6.

In step S103 of FIG. 5, when it is determined that the target user has uttered within the predetermined time (step S103: YES), the control device 110B (the utterance controller 115B) determines that a dialogue with the target user is being executed, and determines utterance contents as a reaction to an utterance of the target user (step S104). The control device 110B (utterance controller 115B) refers to the utterance information DB 123B and the user information DB 121B of the storage 120B, and determines a topic candidate corresponding to utterance contents of the target user and conforming to a preference of the target user.

In this step S104, when there is only one topic candidate determined, the candidate is determined as an eventual topic. On the other hand, when a plurality of topic candidates is determined, and when utterance history information is stored in the storage 120A of the robot 100A, the control device 110B (utterance controller 115B) reads the utterance history information stored in the storage 120A via the communication device 170B. The control device 110B (utterance controller 115B) then determines whether or not a topic that is the same as or related to any one of a plurality of topic candidates and whose elapsed time from the utterance date and time to the present (that is to say the start time of uttering of the robot 100B) is within the predetermined elapsed time (hereinafter referred to as “second comparative topic”) is present in the read utterance history information.

When it is determined that the second comparative topic is present, the control device 110B (utterance controller 115B) excludes, from the plurality of topic candidates, one that matches or is related to the second comparative topic, and eventually determines a topic.

On the other hand, in cases in which a plurality of topic candidates is determined, when no utterance history information is stored in the storage 120A of the robot 100A or when it is determined that the second comparative topic is not present in the utterance history information, one topic randomly selected from the determined plurality of topic candidates is determined as an eventual topic. The utterance controller 115B outputs text data indicating utterance contents conforming to the topic determined as described above.

On the other hand, when it is determined that the target user has not uttered within the predetermined time (step S103: NO), the control device 110B (utterance controller 115B) determines utterance contents to be uttered to the target user (step S105). At this time, the control device 110B (utterance controller 115B) refers to the utterance information DB 123B and the user information DB 121B of the storage 120B, and determines a plurality of topic candidates conforming to a preference of the target user stored in the user information DB 121B. In this case, topics corresponding to Preference degrees A and B are determined as topics that conform to the preference of the target user.

In step S105, when there is only one topic candidate determined, the candidate is determined as an eventual topic. On the other hand, when a plurality of topic candidates is determined, as in the case of step S104, an eventual topic is selected from these plurality of topic candidates. In particular, in cases in which a plurality of topic candidates is determined, when the utterance history information is stored in the storage 120A of the robot 100A, the control device 110B (utterance controller 115B) reads the utterance history information stored in the storage 120A via the communication device 170B. Then, the control device 110B (utterance controller 115B) determines whether or not the second comparative topic is present in the read utterance history information.

When it is determined that the second comparative topic is present, the control device 110B (utterance controller 115B) excludes, from the plurality of topic candidates, one that matches or is related to the second comparative topic, and eventually determines a topic.

On the other hand, in cases in which a plurality of topic candidates is determined, when no utterance history information is stored in the storage 120A of the robot 100A or when it is determined that the second comparative topic is not present in the utterance history information, one topic randomly selected from the determined plurality of topic candidates is determined as an eventual topic.

When the control device 110B utters based on utterance contents conforming to the determined topic (step S106), and a voice is outputted, voice determination processing shown in FIG. 7 for determining a reaction of the target user, facial expression determination processing shown in FIG. 8, and behavior determination processing shown in FIG. 9 are executed. When the behavior determination processing is completed, the preference determination processing shown in FIG. 10 is executed. The control device 110B adds the preference determination result in the preference determination processing to the preference degree information of the user information stored in the user information DB 121B, and updates the preference degree information. The control device 110B controls the communication device 170B, and transmits information in which topics and preference degrees in a dialogue between the target user and the robot 100B are associated with each other to the robot 100A. Likewise, the robot 100A having received this information adds this information to the preference degree information of the user information stored in the user information DB 121A, and updates the preference degree information. As a result, the robot 100A and the robot 100B share the preference determination results thereof.

In Embodiment 1 described above, when one robot of robots 100A and 100B utters within the predetermined elapsed time after utterance of the other robot, a topic uttered by the one robot is determined to be a topic different from a topic uttered by the other robot within a predetermined elapsed time before the utterance of the one robot. In other cases, topics uttered by the robots 100A and 100B are determined irrespectively of each other (independently of each other) without cooperating with each other. Instead of using the above determination method, when the number of pieces of preference information of the target user stored in the user information DB 121A (DB 121B) is smaller than a predetermined threshold value, topics uttered by the robots 100A and 100B may be determined as topics different from each other, and when the number is equal to or larger than the predetermined threshold value, topics uttered by the robots 100A and 100B may be determined irrespectively of each other. In other words, when a predetermined condition is satisfied, topics uttered by the robots 100A and 100B may be determined as topics different from each other, and when the predetermined condition is not satisfied, topics uttered by the robots 100A and 100B may be determined irrespectively of each other. Alternatively, regardless of such a predetermined condition, topics (utterance contents) uttered by the robots 100A and 100B may always be determined irrespectively of each other without cooperating with each other.

### Embodiment 2

In the above-described embodiment, each of the robot 100A and the robot 100B has functions of reaction determination and utterance control, and these functions may be provided separately from the robot 100A and the robot 100B. In the present embodiment, an external server capable of communicating with the robot 100A and the robot 100B is provided, and the server performs reaction determination of the robot 100A and the robot 100B and processing of utterance control of the robot 100A and the robot 100B.

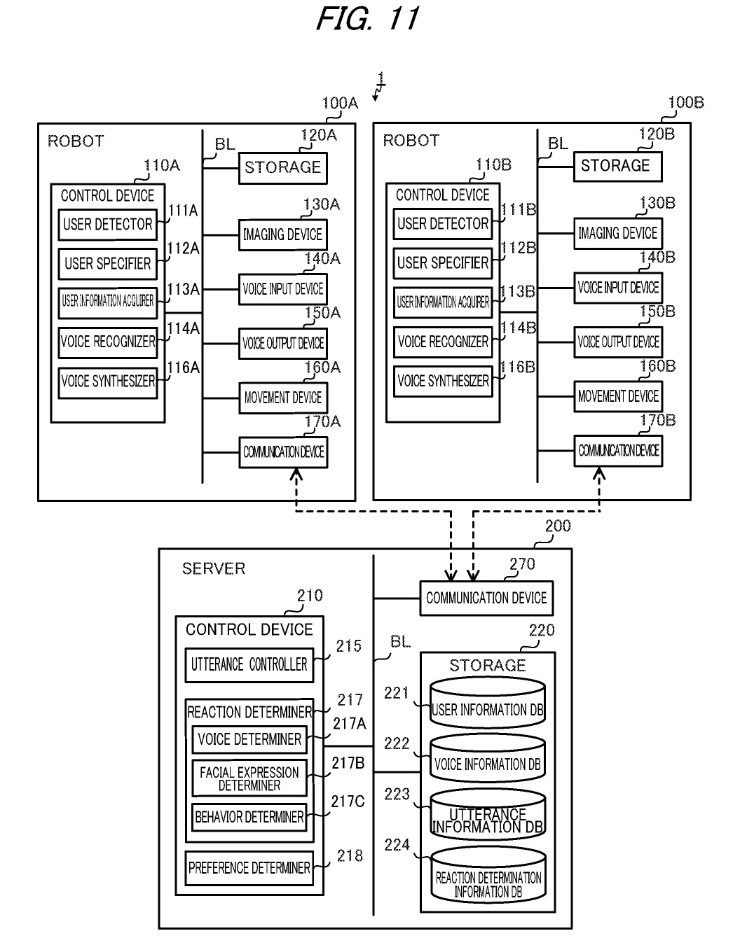

As shown in FIG. 11, the dialogue system 1 in the present embodiment includes the robot 100A, the robot 100B, and a server 200.

As in Embodiment 1, the robot 100A includes the control device 110A, the storage 120A, the imaging device 130A, the voice input device 140A, the voice output device 150A, the movement device 160A, and communication device 170A. However, unlike in the case of Embodiment 1, the control device 110A does not include the utterance controller 115A, the reaction determiner 117A, and the preference determiner 118A. Unlike in the case of Embodiment 1, the storage 120A does not include the user information DB 121A, the voice information DB 122A, the utterance information DB 123A, and the reaction determination information DB 124A. The configuration of the robot 100B is also similar to that of the robot 100A, and the robot 100B includes the control device 110B, the storage 120B, the imaging device 130B, the voice input device 140B, the voice output device 150B, the movement device 160B, and communication device 170B. The control device 110B does not include the utterance controller 115B, the reaction determiner 117B, and the preference determiner 118B. The storage 120B does not include the user information DB 121B, the voice information DB 122B, the utterance information DB 123B, and the reaction determination information DB 124B.

The server 200 includes a control device 210, a storage 220, and a communication device 270. The control device 210 includes an utterance controller 215, a reaction determiner 217, and a preference determiner 218. In other words, in place of the robot 100A and the robot 100B, the server 200 performs various types of processing for controlling utterance of each of the robot 100A and the robot 100B, determining a reaction of a user, determining a preference of the user, and the like. The storage 220 includes a user information DB 221, a voice information DB 222, an utterance information DB 223, and a reaction determination information DB 224. In other words, the databases provided for the robot 100A and the robot 100B are consolidated in the server 200. The storage 220 stores utterance history information including utterance dates and times uttered by the robot 100A and the robot 100B and utterance topics and the like for each user USR. The server 200 performs wireless data communication with the robot 100A and the robot 100B via the communication device 270, the communication device 170A of the robot 100A, and the communication device 170B of the robot 100B. Therefore, the server 200 controls dialogues of the robot 100A and the robot 100B with the target user. The communication devices 170A and 170B thus function as a first communication device. The communication device 270 functions as a second communication device.

Next, the dialogue control processing in the present embodiment will be described. Here, the dialogue control processing of the robot 100A will be described as an example. The control device 110A of the robot 100A starts dialogue control processing at a moment when the user detector 111A detects the user USR around the robot 100A.

Upon starting the dialogue control processing (see FIG. 5), the control device 110A firstly executes user specification processing. The control device 110A searches for a registered user corresponding to a facial image extracted from a captured image acquired from the imaging device 130A. The control device 110A (user specifier 112A) accesses the user information DB 221 in the storage 220 of the server 200, verifies the facial image extracted from the captured image against each facial image of the plurality of users stored in the user information DB 221, and specifies the user USR as the target user.

When the control device 210 of the server 200 having received the information of the user USR determines that the target user has uttered within the predetermined time period, the control device 210 (utterance controller 215) determines that a dialogue with the target user is being executed, and determines utterance contents as a reaction to an utterance of the target user. The control device 210 (utterance controller 215) refers to the utterance information DB 223 and the user information DB 221 of the storage 220, and determines a topic candidate corresponding to the utterance contents of the target user and conforming to a preference of the target user.

When there is only one topic candidate determined, the candidate is determined as an eventual topic. On the other hand, in cases in which a plurality of topic candidates is determined, when utterance history information of the robot 100B is stored in the storage 220, the control device 210 (utterance controller 215) reads the utterance history information stored in the storage 220, and determines whether or not the first comparative topic is present in the read utterance history information.

When it is determined that the first comparative topic is present, the control device 210 (utterance controller 215) excludes, from the plurality of topic candidates, one that matches or is related to the first comparative topic, and eventually determines a topic.

On the other hand, in cases in which a plurality of topic candidates is determined, when no utterance history information of the robot 100B is stored or when it is determined that the first comparative topic is not present in the utterance history information, one topic randomly selected from the determined plurality of topic candidates is determined as the eventual topic. The utterance controller 215 outputs text data indicating utterance contents conforming to a topic determined as described above.

On the other hand, when it is determined that the target user has not uttered within the predetermined time, the control device 210 (the utterance controller 215) determines utterance contents uttered to the target user. At this time, the utterance controller 215 refers to the utterance information DB 223 and the user information DB 221 of the storage 220, and determines a plurality of topic candidates conforming to a preference of the target user stored in the user information DB 221.

When there is only one topic candidate determined, the candidate is determined as an eventual topic. On the other hand, when a plurality of topic candidates is determined, an eventual topic is selected from the plurality of topic candidates. In cases in which a plurality of topic candidates is determined, when utterance history information of the robot 100B is stored, the control device 210 (the utterance controller 215) reads the utterance history information, and determines whether or not the first comparative topic is present.

When it is determined that the first comparative topic is present, the control device 210 (the utterance controller 215) excludes, from the plurality of topic candidates, one that matches or is related to the first comparative topic, and eventually determines a topic.

On the other hand, when a plurality of topic candidates is determined, when nothing is stored in the utterance history information of the robot 100B, or when it is determined that the first comparative topic is not present in the utterance history information, one topic randomly selected from the determined plurality of topic candidates is determined as an eventual topic.

The robot 100A receives text data via the communication device 170A, and transmits the data to the voice synthesizer 116A. The voice synthesizer 116A accesses the voice information DB 222 of the storage 220 of the server 200, and generates voice data from the received text data using an acoustic model or the like stored in the voice information DB 222. The voice synthesizer 116A controls the voice output device 150A, and outputs the generated voice data as a voice.

Subsequently, a reaction determination processing (see FIGS. 7 to 9) for determining a reaction of the target user to an utterance of the robot 100A is executed.

The control device 210 (the voice determiner 217A of the reaction determiner 217) executes voice determination processing (see FIG. 7). The voice determiner 217A determines a reaction of the target user to an utterance of the robot 100A based on a voice generated by the target user after utterance of the robot 100A. When the target user utters, the voice recognizer 114A of the robot 100A accesses the voice information DB 222 of the storage 220 of the server 200, and generates text data from voice data using an acoustic model or the like stored in the voice information DB 222. The text data is transmitted to the server 200. Based on the text data received through the communication device 270, the voice determiner 217A determines a reaction of the target user to utterances of the robot 100A and the robot 100B.

After executing the voice determination processing, the control device 210 (facial expression determiner 217B of the reaction determiner 217) executes facial expression determination processing (see FIG. 8). The facial expression determiner 217B determines a reaction of the target user to an utterance of the robot 100A based on the facial expression of the target user after utterance of the robot 100A. When the user information acquirer 113A of the robot 100A acquires a captured image of a user, the user information acquirer 113A transmits the captured image to the server 200 via the communication device 170A. The facial expression determiner 217B detects a feature quantity of the face of the target user from the captured image acquired via the communication device 270, refers to smile level information stored in the reaction determination information DB 224 of the storage 220, and calculates a smile level of the target user based on the detected feature quantity. The facial expression determiner 217B determines a reaction of the target user to the utterance of the robot 100A according to the calculated smile level.

After executing the facial expression determination processing, the control device 210 executes behavior determination processing (see FIG. 9). A behavior determiner 217C determines a reaction of the target user to an utterance of the robot 100A based on a behavior of the target user after utterance of the robot 100A. The behavior determiner 217C determines a reaction of the target user to an utterance of the robot 100A based on a behavior of the target user detected from a captured image acquired via the communication device 270.

After executing the behavior determination processing, the control device 210 (the preference determiner 218A) executes preference determination processing (see FIG. 10). The preference determiner 218 specifies a topic in a dialogue between the target user and the robot 100A, and determines a preference degree indicating the height of target user's preferences for the topic based on each determination result by the reaction determiner 217.

After executing the preference determination processing, the control device 210 reflects the preference determination result on preference degree information. The control device 210 adds information in which topics and preference degrees in the dialogue between the target user and the robot 100A are associated with each other as the preference determination result in the preference determination processing to the preference degree information of the user information stored in the user information DB 221, and updates the preference degree information. As a result, the preference information is updated for each user USR.

Similar control processing is also performed for the robot 100B. In Embodiment 1, the robot 100A updates preference degree information in a dialogue between the target user and the robot 100A, and transmits the information to the robot 100B. Likewise, the robot 100B having received this information updates preference degree information stored in the user information DB 121B. As a result, the robot 100A and the robot 100B can share the preference determination results thereof. On the other hand, in the present embodiment, since preference degree information of the robot 100A and the robot 100B is stored for each user USR in the user information DB 221 of the server 200, it is unnecessary to update each other's preference degree information.

In the above embodiment, the server 200 executes various types of processing such as control of an utterance of each of the robot 100A and robot 100B, determination of a reaction of a user, and determination of a preference of a user. However, processing performed by the server 200 is not limited thereto, and the server 200 can select and execute arbitrary processing of the robot 100A and the robot 100B. For example, the control device 210 of the server 200 may include only the utterance controller 215 and execute only utterance control processing of the robot 100A and the robot 100B, and the other processing may be executed by the robot 100A and the robot 100B. The server may execute all processing of user detection, user specification, user information acquisition, voice recognition, voice synthesis, utterance control, reaction determination, and preference determination of the robot 100A and the robot 100B. In the present embodiment, the storage 220 of the server 200 includes the user information DB 221, the voice information DB 222, the utterance information DB 223, and the reaction determination information DB 224. However, the present invention is not limited thereto, and the server 200 can include any database. For example, in the present embodiment, the voice information DB 222 may not be provided in the server 200, and may be provided in each of the robot 100A and the robot 100B. Face information specifying a user of the user information DB 221 may be provided not only in the server 200 but also in each of the robot 100A and the robot 100B. By this, the robot 100A and the robot 100B do not need to access the server 200 in voice recognition, voice synthesis, and user specification.

As described above, according to Embodiment 1, the dialogue system 1 includes the robot 100A and the robot 100B. The utterance by each of the robots 100A and 100B is controlled based on a result of determining a reaction of the target user to an utterance by the robot 100A (that is to say preference information of the target user) and a result of determining a reaction of the target user to an utterance by the robot 100B (that is to say preference information of the target user).

According to Embodiment 2, the dialogue system 1 includes the robot 100A, the robot 100B, and the server 200, and the server 200 controls utterance by each of the robots 100A and 100B based on a result of determining a reaction of the target user to an utterance by the robot 100A (that is to say preference information of the target user) and a result of determining a reaction of the target user to an utterance by the robot 100B (that is to say preference information of the target user). As a result of Embodiment 1 and Embodiment 2, it is possible to accurately and efficiently grasp user's preferences and have a dialogue suitable for the user's preferences.

It should be noted that the present disclosure is not limited to the above embodiments, and various modifications and applications are possible. The above embodiments may be modified as follows.

In the above embodiments, the robot 100A and the robot 100B are provided at places where utterances of both robots are not recognized by the target user. On the other hand, a modified example in cases in which the robot 100A and the robot 100B are provided at places where utterances of both robots are recognized by the target user will be described. In this case, the robot 100A and the robot 100B can concurrently have a dialogue with the target user. However, when utterance times of the robot 100A and the robot 100B overlap or continue, there is a possibility of incapable of appropriately determining which utterance the target user reacted to. Then, it is impossible to appropriately acquire preference information of the target user, and an appropriate reaction cannot be made. Therefore, the utterance controller 115A (115B) determines timing of utterance start of the robot 100A (100B) in cooperation with the utterance controller 115B of the robot 100B (the utterance controller 115A of the robot 100A) in order to prevent the utterance times by the robot 100A and the robot 100B from overlapping or continuing. The utterance controller 115A (115B) determines utterance start timing of the robot 100A (100B) in such a manner that an utterance interval between the robot 100A and the robot 100B is equal to or longer than a predetermined time such as a time sufficient for determining a reaction of the target user. The utterance controller 115B of the robot 100B (the utterance controller 115A of the robot 100A) determines the utterance start timing of the robot 100B (100A) in such a manner that the robot 100B (100A) does not utter during and continuously immediately after the end of the utterance of the robot 100A (100B). The utterance start timing of the robot 100A and the robot 100B may be determined by each of the utterance controllers 115A and 115B, or by one of the controllers 115A and 115B. When the server 200 controls the utterance of the robot 100A and the robot 100B, the utterance controller 215 determines the utterance start timings of both of the robots 100A and 100B. By this, utterances by the robot 100A and the robot 100B do not follow each other continuously, but occur at timings different from each other by a predetermined time or more. As a result, it is possible to accurately grasp target user's preferences and to have a dialogue suitable for the target user's preferences.

Further, in the above modification, the utterance controller 115A may determine topics uttered by the robot 100A and the robot 100B as topics different from each other in cooperation with the utterance controller 115B of the robot 100B. In this case, as in the case of Embodiment 1, in cases in which the other robot utters within the predetermined elapsed time after utterance of one of the robots 100A and 100B, a topic uttered by the other robot may be determined as a topic different from a topic uttered by one robot within a predetermined elapsed time before utterance of the other robot, and in other cases, topics uttered by the robots 100A and 100B may be determined irrespectively of each other (independently of each other) without cooperating with each other. Alternatively, in this case, when the number of pieces of preference information of the target user stored in the user information DB 121A (DB 121B) is smaller than a predetermined threshold value, topics uttered by the robots 100A and 100B are determined as topics different from each other, and when the number of pieces of preference information is equal to or larger than the predetermined threshold value, topics uttered by the robots 100A and 100B may be determined irrespectively of each other. Alternatively, regardless of the predetermined condition as described above, topics (utterance contents) uttered by the robots 100A and 100B may be always determined irrespectively of each other without cooperating with each other.

For example, the dialogue system 1 may be provided with a movement controller for controlling the movement device 160A according to control of utterance of the utterance controller 115A. For example, the movement controller may control the movement device 160A in such a manner that the robot 100A approaches the target user in accordance with utterance start of the robot 100A.

For example, a master/slave system may be adopted for a plurality of robots 100 constituting the dialogue system 1, and for example, the robot 100 functioning as a master collectively may determine utterance contents of the robot 100 functioning as a slave, and may instruct the robot 100 functioning as a slave to utter based on the determined utterance contents. In this case, any method of determining the robot 100 functioning as a master and the robot 100 functioning as a slave may be employed, and for example, a robot that first detects and specifies the user USR therearound may function as a master, and another robot 100 may function as a slave. For example, the robot 100 which is first powered on by a user USR may function as a master, and the robot 100 which is subsequently powered on may function as a slave, or a user USR may use a physical switch or the like in such a manner that the robot 100 functioning as a master and the robot 100 functioning as a slave can be set.

The robot 100 functioning as a master and the robot 100 functioning as a slave may be predetermined. In this case, part of functions executable by the robot 100 functioning as a slave may be omitted. For example, when uttering according to an instruction of the robot 100 functioning as a master, the robot 100 functioning as a slave may not have a function equivalent to the utterance controller 115A or the like.

Although, in the above-described embodiment, an example in which the robot 100A and the robot 100B have a dialogue with the target user has been described, the dialogue system 1 may be configured to have a dialogue with a target user by one robot 100. In this case, for example, one robot 100 collectively determines contents of its own utterance and contents of utterance of another robot similarly to the above-described case in which the robot 100 functions as a master, sequentially outputs voices of the determined utterance contents by changing a voice color or the like, and one robot 100 may also represent an utterance of another robot.

Although, in the above embodiment, a case in which the dialogue system 1 is a robot system including a plurality of robots 100 has been described as an example, the dialogue system 1 may be constituted by a plurality of dialogue apparatuses including all or a part of the configuration of the robot 100.

In the above embodiment, a control program executed by the CPU of the control devices 110A and 110B is stored in the ROM or the like in advance. However, the present disclosure is not limited thereto, and by implementing a control program for executing the above-described various types of processing in an electronic device such as an existing general-purpose computer, a framework, or a workstation, such a device may be made to function as a device corresponding to the robots 100A and 100B according to the above embodiment. Examples of an utterance device corresponding to the robots 100A and 100B include a mobile terminal having a voice assistant function, and a digital signage. Digital signage is a system that displays video and information on an electronic display device such as a display. Note that the utterance is not limited to outputting a voice by a speaker, but also includes displaying a character on a display equipment. Therefore, a mobile terminal displaying utterance in text, digital signage, and the like are also included as utterance devices corresponding to the robots 100A and 100B.

Such a program may be provided in any way, and may be stored in, for example, a computer-readable recording medium (such as, a flexible disk, a compact disc (CD)-ROM, a digital versatile disc (DVD)-ROM), or the like and distributed, or may be stored in a storage on a network such as the Internet and provided by downloading.

In cases in which the above processing is executed by sharing an operating system (OS) and an application program or by cooperation between an OS and an application program, only an application program may be stored in a recording medium or a storage. It is also possible to superimpose a program on a carrier wave and distribute the program via a network. For example, the program may be posted on a bulletin board system (BBS) on a network, and the program may be distributed via the network. The processing may be executed by activating a distributed program and executing the program in the same manner as other application programs under control of an OS.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

What is claimed is:

1. A dialogue control device comprising:
a processor configured to
acquire reaction determination results that include a result obtained by determining a reaction of a predetermined target to an utterance by a first utterance device and a result obtained by determining a reaction of the predetermined target to an utterance by a second utterance device provided separately from the first utterance device, and
control, based on the acquired reaction determination results, the utterance by at least one of a plurality of utterance devices including the first and second utterance devices.

2. The dialogue control device according to claim 1, wherein the processor is configured to acquire the reaction determination results that include a result obtained by determining a reaction of the predetermined target to each of utterances by the first and second utterance devices in cases in which a location where the utterance is performed to the predetermined target by the first utterance device and a location where the utterance is performed to the predetermined target by the second utterance device are such places that both of the utterances by the first and second utterance devices are unrecognizable by the predetermined target.

3. The dialogue control device according to claim 1, wherein the processor is configured to control the utterances by the first and second utterance devices to be performed in such a manner that the utterances occur, without following each other continuously, at timings different from each other by a predetermined time or more.

4. The dialogue control device according to claim 1, wherein the processor is configured to determine topics of the utterances by the first and second utterance devices to be topics different from each other.

5. The dialogue control device according to claim 1, wherein the processor is configured to determine contents of the utterances by the first and second utterance devices irrespectively of each other.

6. The dialogue control device according to claim 1, wherein the reaction determination results are results obtained by determination of reactions of the predetermined target to the utterances by the first and second utterance devices, the determination being based on at least one of a voice uttered by the predetermined target or a captured image of the predetermined target.

7. The dialogue control device according to claim 1, wherein the processor is configured to
acquire at least one of a voice uttered by the predetermined target or a captured image of the predetermined target, and
acquire the reaction determination results by determining, based on the at least one of the acquired voice or the acquired captured image, a reaction of the predetermined target to the utterance by each of the first and second utterance devices.

8. The dialogue control device according to claim 7, wherein
the processor has at least one of
(i) a voice determination function that determines, based on the acquired voice, contents of the voice of the predetermined target to the utterance by each of the first and second utterance devices,
(ii) a facial expression determination function that determines, based on the acquired captured image, facial expression of the predetermined target to the utterance by each of the first and second utterance devices, or
(iii) a behavior determination function that determines, based on the acquired captured image, a behavior of the predetermined target to the utterance by each of the first and second utterance devices, and
the processor is configured to acquire the reaction determination results by determining a reaction of the predetermined target to the utterance by each of the first and second utterance devices, the determining being based on a determination result by the at least one of the voice determination function, the facial expression determination function, or the behavior determination function.

9. The dialogue control device according to claim 8, wherein the processor is configured to determine the reaction of the predetermined target by classifying the reaction of the predetermined target as a positive reaction, a negative reaction, a neutral reaction that is neither positive nor negative, based on at least one of the voice, the facial expression, or the behavior of the predetermined target.

10. The dialogue control device according to claim 7, wherein the processor is configured to
specify a topic in a dialogue with the predetermined target based on at least one of the voice uttered by the predetermined target, the utterance by the first utterance device, or the utterance by the second utterance device,
determine, based on the acquired reaction determination results, a preference degree indicating a degree of a preference of the predetermined target for the specified topic, and
control the utterance by the at least one of the plurality of utterance devices based on the determined preference degree.

11. The dialogue control device according to claim 10, wherein the preference is an interest or a preference relating to things regardless of whether the things are tangible or intangible, and include interests or preferences relating to food, sports, and weather, and preferences for utterance contents of at least one of the first and second utterance devices.

12. The dialogue control device according to claim 10, wherein the processor is configured to
determine the preference degree into a plurality of stages in descending order of the preference of the predetermined target for the topic; and
control the utterance by the at least one of the plurality of utterance devices based on information of the plurality of stages indicating the determined preference degree.

13. The dialogue control device according to claim 1, wherein the predetermined target is a person, an animal, or a robot.

14. The dialogue control device according to claim 1, wherein the processor is configured to
specify the predetermined target from a plurality of different targets; and
acquire reaction determination results that include a result obtained by determining a reaction of the specified predetermined target to the utterance by the first utterance device and a result obtained by determining a reaction of the specified predetermined target to the utterance by the second utterance device provided separately from the first utterance device.

15. The dialogue control device according to claim 1, wherein the dialogue control device is provided in at least one of the first and second utterance devices.

16. The dialogue control device according to claim 1, wherein the dialogue control device is provided separately from the first and second utterance devices.

17. A dialogue system comprising:
a first utterance device and a second utterance device that are configured to be able to utter; and
a dialogue control device comprising a processor configured to
acquire reaction determination results that include a result obtained by determining a reaction of a predetermined target to an utterance by the first utterance device and a result obtained by determining a reaction of the predetermined target to an utterance by the second utterance device provided separately from the first utterance device; and
control, based on the acquired reaction determination results, the utterance by at least one of a plurality of utterance devices including the first and second utterance devices.

18. The dialogue system according to claim 17, wherein
each of the first and second utterance devices comprises
a processor configured to acquire at least one of a voice uttered by the predetermined target or a captured image of the predetermined target, and
a first communication device,
the dialogue control device further comprises a second communication device for communicating with the first and second utterance devices via the first communication device,
the processor of the dialogue control device is configured to
acquire first data that is at least one of the voice or the captured image acquired by the processor of the first utterance device via the first and second communication devices, and acquire a first reaction determination result that is a determination result of a reaction of the predetermined target to the utterance by the first utterance device by determining a reaction of the predetermined target to the utterance by the first utterance device based on the acquired first data,
acquire second data that is the at least one of the voice or the captured image acquired by the processor of the second utterance device via the first and second communication devices, and acquire a second reaction determination result that is a determination result of a reaction of the predetermined target to the utterance by the second utterance device by determining a reaction of the predetermined target to the utterance by the second utterance device based on the acquired second data, and
control the utterance by the first and second utterance devices via the second and first communication devices based on the reaction determination results including the acquired first and second reaction determination results.

19. A dialogue control method comprising:
acquiring reaction determination results that include a result obtained by determining a reaction of a predetermined target to an utterance by a first utterance device and a result obtained by determining a reaction of the predetermined target to an utterance by a second utterance device provided separately from the first utterance device; and
controlling, based on the acquired reaction determination results, the utterance by at least one of a plurality of utterance devices including the first and second utterance devices.

20. A non-transitory computer-readable recording medium storing a program, the program causing a computer to function as
a reaction acquirer for acquiring reaction determination results that include a result obtained by determining a reaction of a predetermined target to an utterance by a first utterance device and a result obtained by determining a reaction of the predetermined target to an utterance by a second utterance device provided separately from the first utterance device, and
an utterance controller for controlling, based on the reaction determination results acquired by the reaction acquirer, the utterance by at least one of a plurality of utterance devices including the first and second utterance devices.
